(19) United States
(12) Patent Application Publication
(10) Pub. No.: US 2007/0024194 A1
(43) Pub. Date: Feb. 1, 2007

(54) Plasma display panel

(76) Inventor: Soon-Bae Kim, Suwon-si (KR)

Correspondence Address: Robert E. Bushnell, Suite 300, 1522 K Street, N.W., Washington, DC, 20005, US

(21) Appl. No.: 11/494,448

(22) Filed: Jul. 28, 2006

(30) Foreign Application Priority Data
Jul. 29, 2005 (KR) 10-2005-0069460

(51) Int. Cl. H01J 17/49

(52) U.S. Cl. 313/582

(57) ABSTRACT

A plasma display panel is provided to reduce emission of unnecessary light from non display area thereof, while maintaining discharging stability of discharge cells in the display area thereof. The area of the plasma display panel is divided into a display area and non-display area, and sustain discharge is generated in the display area to produce visible light and therefore to display an image. Sustain and scan electrode formed on a substrate of the plasma display panel, however, extend into the non-display area, and could drive sustain discharge in the non-display area, which would cause low contrast ratio in the display area and high power consumption of the plasma display panel. The present invention provides sustain and scan electrodes that have different shapes in the display area and non-display area. The electrode structure of the present invention prevents unnecessary discharge from being generated in the non-display area, while providing sufficient charges to discharges cells located around boundary of the display area, and therefore improves discharge stability and contrast ratio in the display area.

### CLAIM OF PRIORITY

This application makes reference to, incorporates the same herein, and claims all benefits accruing under 35 U.S.C. §119 from an application for, A PLASMA DISPLAY PANEL, earlier filed in the Korean Intellectual Property Office on 29 Jul. 2005 and there duly assigned Serial No. 10 2005 0069460.

### BACKGROUND OF THE INVENTION

1. Technical Filed

The present invention relates to a plasma display panel, and in particular, to a plasma display panel that reduces emission of unnecessary light (neon light) from non-display area thereof, while maintaining discharging stability of discharge cells located near the boundary of in the display area thereof.

2. Description of the Related Art

In general, a plasma display panel (PDP) is a display device that uses gas discharge to produce an image and has excellent display characteristics such as display capacity, luminance, contrast, afterimage (or residual image), and viewing angle.

The PDP includes a front substrate having sustain electrodes and scan electrodes, and a rear substrate having address electrodes. Both substrates are joined hermetically at their edges. Discharge cells are formed in the space between the front substrate and the rear substrate, and defined by barrier ribs placed therebetween. The discharge cells are filled with a discharge gas (a gas mixture of neon and xenon for example).

In the PDP, a discharge cell to be turned on is selected during address discharge, and sustain discharge is generated in the selected discharge cell to produce an image thereby. In other words, by applying address voltage to the address electrode and scan voltage to the sustain electrode at the same time, address discharge occurs between both electrodes. Wall charges are accumulated by the address discharge in the discharge cell that is selected to be turned on.

Sequentially, alternating sustain voltage is applied between the scan electrode and the sustain electrode, and then electrons and ions near the scan electrode and the sustain electrode move to electrodes that have opposite polarity to the electrons and ions. When the sum of the voltage of the sustain voltage and the wall voltage produced by the wall charge exceeds a firing voltage, the sustain discharge starts in the selected discharge cell. Ultraviolet ray generated from the sustain discharge excites a corresponding phosphor layer. The excited phosphor emits visible light while the atoms of the phosphor returns to the ground state.

Each of the scan electrode and the sustain electrode has a transparent electrode generating the sustain discharge inside each of discharge cells, and a bus electrode supplying voltage to the transparent electrode.

On the other hand, the PDP has a display area formed to produce an image, and a non-display area formed outside the display area, producing no image. The non-display area has terminals for the connection to electronic circuits for driving the PDP.

If the transparent electrodes are not formed in the non-display area, no substantial sustain discharge is generated in the non-display area. In this case, however, the discharge cells placed near the boundary of the display area (outermost discharge cells) are not sufficiently supplied with charges through the neighboring discharge cells. Therefore, lack of the sufficient charges deteriorates the discharging stability of discharge cells placed near the boundary of in the display area.

If transparent electrodes are formed in the non-display area, the outermost discharge cells in the display area are supplied with charges through the neighboring discharge cells. However, unnecessary sustain discharge may be generated in the non-display area, and a contrast ratio of the display are decreases due to light emitted from the non-display area. Also, the power consumption increases due to the increase of the discharge current used to generate unnecessary sustain discharge in the non-display area.

### SUMMARY OF THE INVENTION

The object of the present invention is to provide a plasma display panel that reduces emission of unnecessary light from non-display area thereof, while maintaining discharging stability of the discharge cell placed near a boundary of the display area thereof.

A plasma display panel constructed as an embodiment of the present invention includes a first substrate, a second substrate facing the first substrate, address electrodes disposed on the first substrate and extending in a first direction, a first electrode and a second electrode both disposed on the second substrate and extending in a second direction, barrier ribs formed in the space between the first substrate and the second substrate, and a phosphor layer formed on a side of the barrier ribs.

The first substrate and the second substrate face each other with a space formed therebetween, and the space includes a display area for displaying an image and a non-display area that is formed outside the display area and displays no image. The first electrode includes a first transparent electrode and a first bus electrode, and the first transparent electrode includes a first sub-electrode formed in the non-display area. A shape of the first sub-electrode is different from a shape of the portion of the first transparent electrode formed in the display area. Intersections of the address electrodes with a pair of the first and the second electrodes define and form discharge cells in the space between the first substrate and the second substrate. Each of discharge cells is formed either in the display area or in the non-display area.

The second electrode may include a second transparent electrode and a second bus electrode, and the second transparent electrode includes a second sub-electrode formed in the non-display area. A shape of the second sub-electrode maybe different from a shape of the portion of the second transparent electrode formed in the display area.

The first sub-electrode and the second sub-electrode may be substantially parallel to each other, and separated from each other with a predetermined gap. The first transparent electrode formed in the display area and the second transparent electrode formed in the display area are separated from each other with a predetermined gap, and the gap between the first transparent electrode and the second transparent electrode both formed in the display area is substantially the same as the gap between the fist sub-electrode and the second sub-electrode. A width of the first sub-electrode is smaller than a width of the portion of the first transparent electrode formed in the display area, and a width of the second sub-electrode is smaller than a width of the portion of the second transparent electrode formed in the display area.

The first sub-electrode may include a first member extending substantially in the first direction from the first bus electrode and a second member extending substantially in the second direction from an end of the first member. The first member may substantially cover one of the barrier ribs that extends in the first direction, and the first member may be formed adjacent to a boundary of the display area.

The first sub-electrode may include a plurality of first members extending substantially in the first direction from the first bus electrode and a second member that extends substantially in the second direction and connects to ends of the first members. In this case, width of the first member may increase proportionally to the distance from the first member to a boundary of the display area.

The discharge cells formed in the non-display area may include at least two sub-discharge cells with each of the sub-discharge cells being surrounded by the barrier ribs.

The barrier ribs may include a plurality of first barrier rib members extending in the first direction and a plurality of second barrier rib members extending in the second direction. Each of the first barrier rib members crosses at least one of the second barrier rib members. The barrier ribs may further include a plurality of third barrier rib members that are formed in the non-display area and extend in the second direction. Both of a pair of the first sub-electrode and the second sub-electrode and one of the third barrier rib members maybe disposed between the second barrier rib members, and the third barrier rib member may be also disposed between the first sub-electrode and the second sub-electrode.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial perspective view of a disassembled plasma display panel constructed as a first embodiment of the present invention.

FIG. 2 is a partial plan view illustrating schematically the arrangement of electrodes and barrier ribs of FIG. 1.

FIG. 3 is a cross-sectional view of the assembled plasma display panel taken on the line III-III′ of FIG. 1.

FIG. 4 is a partial plan view illustrating schematically the arrangement of electrodes and barrier ribs of a plasma display panel constructed as a second embodiment of the present invention.

FIG. 5 is a partial plan view illustrating schematically the arrangement of electrodes and barrier ribs of a plasma display panel constructed as a third embodiment of the present invention.

### DETAILED DESCRIPTION OF THE INVENTION

Hereinafter, the embodiments of the present invention will be described in detail with reference to drawings. However, the present invention may have different forms, and is not limited to these embodiments. In order to clarify the explanation on the present invention, irrelevant explanation to the present invention is omitted, and the same reference numeral is given to the same or similar components throughout the whole specification.

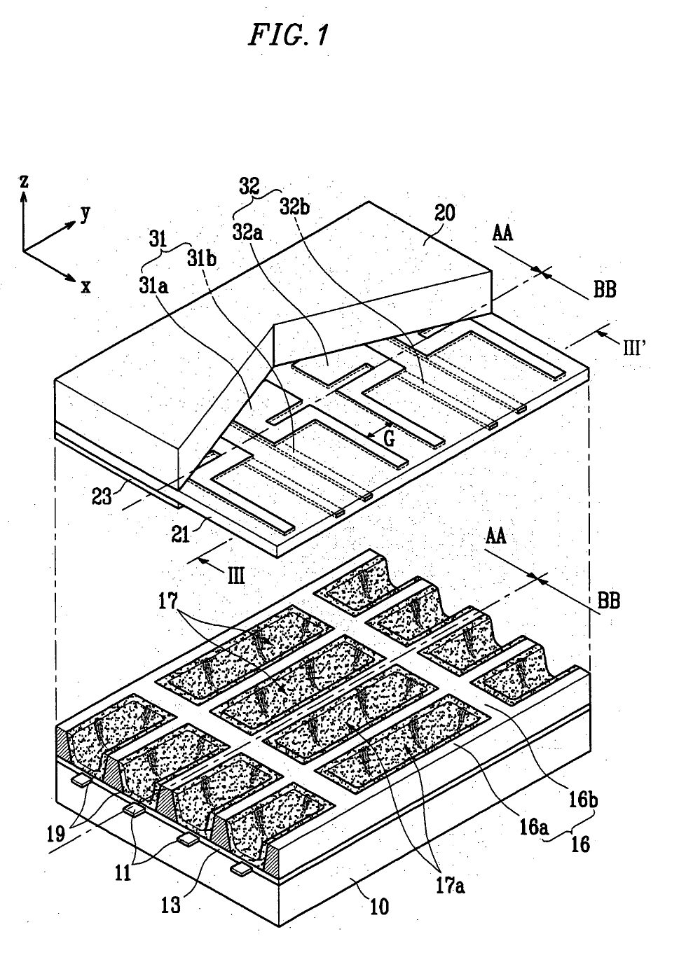

In a first embodiment of the present invention, as shown in FIGS. 1 to 3, a plasma display panel (PDP) includes rear substrate 10, front substrate 20 placed facing rear substrate 10 and apart from rear substrate 10 with a predetermined gap, and barrier ribs 16 formed in the space between rear substrate 10 and front substrate 20.

Barrier ribs 16 are formed in the space between rear substrate 10 and front substrate 20, and define a plurality of discharge cells 17 that are also formed in the space between rear substrate 10 and front substrate 20. Discharge cells 17 have phosphor layer 19 absorbing ultraviolet ray so as to emit visible light, and are filled with a discharge gas (for example, a gas mixture of xenon and neon, etc).

In the PDP, address electrode 11, first electrode 31 (or sustain electrode) and second electrode 32 (or scan electrode) are formed corresponding to each discharge cell 17. These electrodes are involved in plasma discharging process that generates ultraviolet ray. As the ultraviolet ray is absorbed in phosphor layer 19, visible light is emitted from phosphor layer 19.

More specifically, first electrode 31 and second electrode 32 extends in a second direction (x direction), on the inner surface of front substrate 20, over discharge cells 17 sequentially positioned along the first direction. A plurality of the address electrodes 11 are placed parallel to one another on the inner surface of rear substrate 10, and extend in a first direction (y direction), which is substantially perpendicular to the first direction, below discharge cells 17 sequentially placed along the second direction. The intersections of address electrode 11 and a pair of first electrode 31 and second electrode 32 defines a discharge cells 17.

Address electrodes 11 are covered with dielectric layer 13 that prevents the address electrode from being damaged, and works to form and accumulate wall charges during discharging process. Also, since visible light produced during the discharging process is not required to transmit through rear substrate 10, address electrode 11 formed on rear substrate 10 may be made of a metallic electrode with high electric conductance.

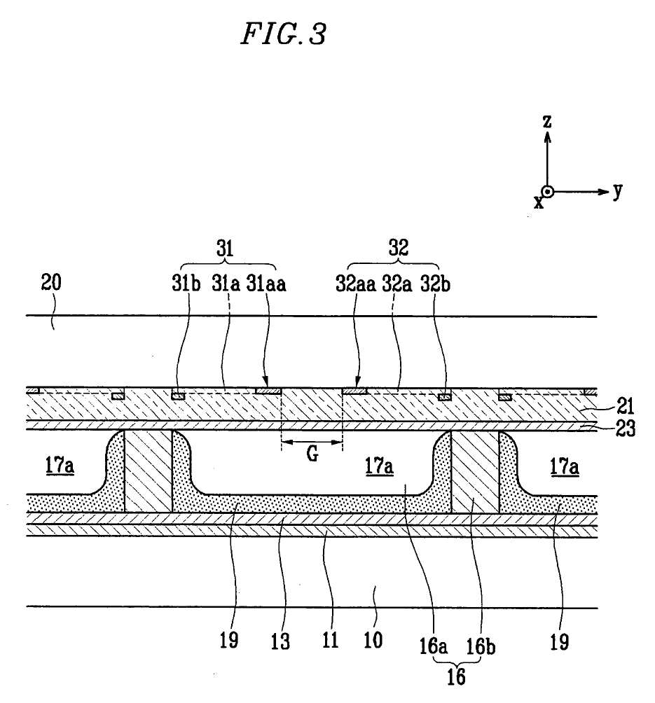

Barrier ribs 16 are formed on the top of dielectric layer 13, and physically define discharge cells 17. Barrier rib 16, as shown in FIGS. 1 and 3, may include first barrier rib members 16a extending in the first direction (y direction) and a second barrier rib members 16b extending in the second direction (x direction). Each of first barrier rib members 16a is positioned between two neighboring address electrodes 11, and formed parallel to address electrodes 11. Each of second barrier rib members 16b is positioned between two pairs of sustain electrode 31 and the scan electrode 32 as shown in FIG. 3.

Accordingly, first barrier rib members 16a and second barrier rib members 16b form a plurality of closed structures as shown in FIG. 1, where discharge cell are defined inside each of the closed structure, and therefore the closed structure may effectively reduce cross talks between discharge cells 17.

The plan shape of the closed structure of the barrier ribs is not limited to a rectangular shape, and may be formed into various shapes such as hexagon and octagon. Furthermore, it is possible to form open structures, where barrier ribs 16 are only composed of first barrier rib members 16a and discharge cells formed along address electrodes 11 are not isolated from each other.

Phosphor layer 19 is formed on the inner sides of barrier ribs 16 and on the surface of dielectric layer 13 that is surrounded by barrier ribs 16. That is, phosphor layer 19 is formed on the inner sides of first barrier rib members 16a, the inner sides of second barrier rib members 16b, and on the surface of dielectric layer 13 that is surrounded by first barrier rib members 16a and second barrier rib members 16b.

Sustain electrodes 31 and scan electrodes 32 are formed on the inner surface of the front substrate 20, and extend in the second direction (x direction) crossing address electrodes 11 formed on rear substrate 10. Sustain electrodes 31 and scan electrodes 32, both of which correspond to each of discharge cells 17, define a surface discharge structure.

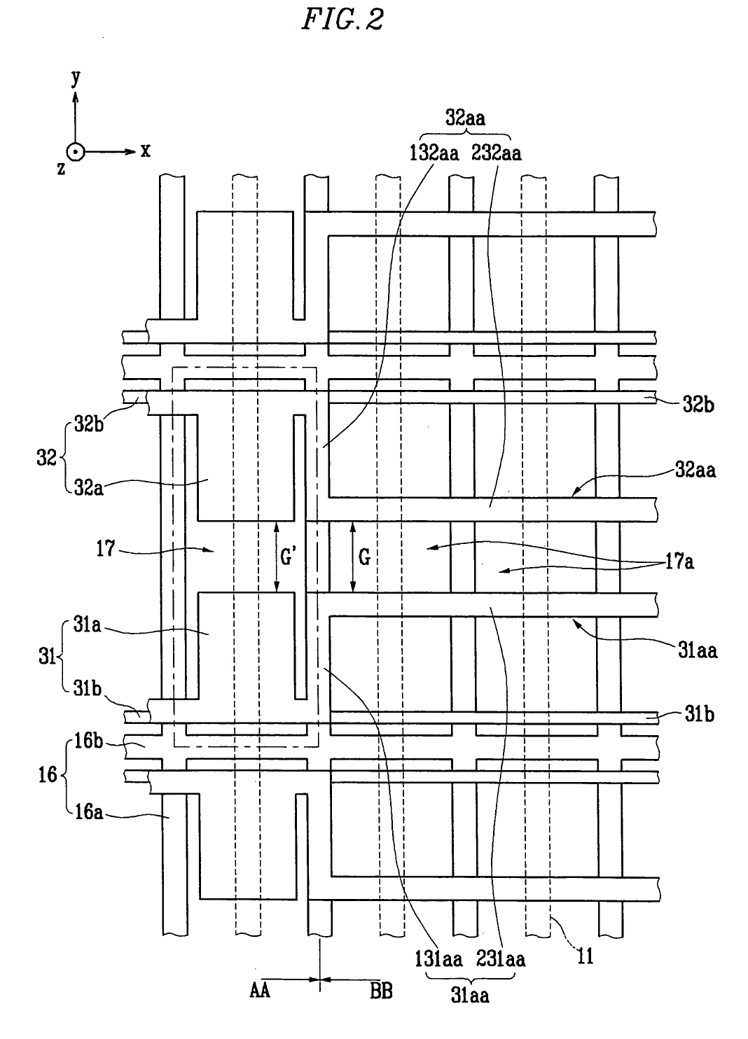

Sustain electrodes 31 and scan electrodes 32 include respective transparent electrodes 31a and 32a, and respective bus electrodes 31b and 32b. Bus electrodes 31b and 32b extend in the second direction (x direction), substantially parallel to and near second barrier rib members 16b. Transparent electrodes 31a and 32a are formed on the inner surface of the front substrate 20 but on a different layer from the layer on which bus electrodes 31b and 32b are formed, and shifted on the layer toward the center of discharge cell 17. There is gap G′ (shown in FIG. 2) between transparent electrode 31a of sustain electrode 31 and transparent electrode 32a of scan electrode 32, where gap G′ defines a surface discharge are inside each of discharge cells 17. Gap G′ is defined as a discharging gap. In the present embodiment, bus electrodes 31b and 32b are placed in the vicinity of second barrier ribs member 16b as shown in FIG. 2, and may be formed right above and passing along second barrier ribs member 16b.

Transparent electrodes 31a and 32a are the electrodes involved in the surface discharge inside each of discharge cells 17, and may be made of indium tin oxide (ITO), which is a transparent material in visible light, to obtain a high opening ratio. Preferably, bus electrodes 31b and 32b may be made of a metallic material to obtain high conductivity for compensating relatively low conductivity of transparent electrodes 31a and 32a. Sustain electrodes 31 and scan electrodes 32 are covered with dielectric layer 21 that prevents sustain electrodes 31 and scan electrodes 32 from being damaged. Dielectric layer 21 also works to form and to accumulate wall charges during discharging process.

Protective layer 23 is formed on the top of dielectric layer 21. Protective layer 23 may be made of transparent magnesium oxide (MgO), and may work to protect dielectric layer 21 and increase a secondary electron emission coefficient during the discharging process.

In order to drive the PDP, reset discharge is first generated by reset pulses applied to scan electrode 31 during a reset period. And then, address discharge is generated by address pulses applied to address electrode 11 and scan pulses applied to scan electrode 31 during an address period following the reset period. Then, sustain discharge is generated by sustain pulses applied to sustain electrode 31 and scan electrode 32. In other words, the address discharge generated by voltage between address electrode 11 and scan electrode 32 selects discharge cell 17 to be turned on, and the sustain discharge generated by voltage between sustain electrode 31 and scan electrode 32 generates the sustain discharge inside selected discharge cell 17 that would produce visible light to display an image.

In the present embodiment, the sustain pulses are applied to sustain electrode 31 and scan electrode 32 for sustain discharge. The reset pulses and the scan pluses are applied to the scan electrode 32, and the address pulses are applied to address electrode 11. However, the functions of these electrodes may vary depending on the waveform and voltages of the applied pulses, and therefore are not limited to the above mentioned functions.

Also, address electrodes 11, sustain electrodes 31, and scan electrodes 32 have electric terminals (not shown) that may connect these electrodes to a circuit board (not shown).

Thus, since the electrodes have the terminals at their ends to connect to the circuit board, the area of the PDP may be divided into display area AA producing an image, and non-display area BB formed outside the display area and producing no image.

Sustain electrodes 31 and scan electrodes 32 both formed in display area AA are involved in the sustain discharge to produce an image. Sustain electrodes 31 and scan electrodes 32 disposed in non-display area BB have different shapes from the shapes of sustain electrodes 31 and scan electrodes 32 of display area AA. For example, discharging gap G of non-display area BB may be the same as discharging gap G′ of display area AA, but sustain electrodes 31 and scan electrodes 32 formed in non-display area BB may have narrower width than width formed in display area AA (refer to FIG. 2).

Herein, width of a sustain or scan electrode is defined as a size of the electrode along a direction that is perpendicular to the extending direction of the electrode, while length of the electrode as a size of the electrode along the extending direction of the electrode. In this embodiment, the width of the sustain electrode is a size along y-direction, and length of the electrode as a size of the electrode along x-direction, because the sustain electrode is described as extending in x-direction. The same definition applies to other electrodes. If an electrode is not rectangular, and has portions of other shapes such as triangular, circular, or elliptical, width of the electrode is defined as an average width over the length of the electrode.

By this arrangement, sustain electrodes 31 and scan electrodes 32 formed in non-display area BB are not involved in the sustain discharge, but may supply charges to discharge cells 17 located around boundary of display area AA. Herein, discharge cells 17 of display area AA disposed around the boundary of display area AA are defined as outermost discharge cells. Compared to an electrode structure where shapes of sustain and scan electrodes in display area and non-display area are the same, sustain discharge is hardly generated in non-display area BB in this arrangement, because of the different shapes of sustain and scan electrodes between display area AA and non-display area BB. Therefore, unnecessary generation of light in non-display area BB is prevented in this arrangement, and contrast ratio would be improved in display area AA, because of no sustain discharge and no generation of light in non-display area BB. Moreover, even though there is no sustain discharge in non-display area BB, charges are still supplied to sustain and scan electrodes disposed in non-display area. Therefore, the sustain discharge in outermost discharge cells in display area AA may be stabilized by charges supplied to sustain and scan electrodes of non-display area BB.

Sustain electrodes 31 and scan electrodes 32 maybe formed into various shapes in non-display area BB. In the present embodiment, sustain electrodes 31 and scan electrodes 32 formed in non-display area BB have sustain sub-electrodes 31aa (or first sub-electrode) and scan sub-electrode 32aa (or second sub-electrode), respectively. However, it is not necessary for both of sustain electrodes 31 and scan electrodes 32 to have the sub-electrode. The sub-electrode may be formed in only one of sustain electrodes 31 and scan electrodes 32.

In non-display area BB, sustain sub-electrode 31aa of sustain electrode 31 and scan sub-electrode 32aa of scan electrode 32 form a pair, and placed substantially parallel to each other. That is, at least one pair of sustain sub-electrode 31aa and scan sub-electrode 32aa is placed corresponding to each of discharge cells 17 in non-display area BB, and there is discharging gap G between sustain sub electrode 31aa and scan sub-electrode 32aa in non-display area as shown in FIG. 2.

Discharging gap G between sustain sub-electrode 31aa and scan sub-electrode 32aa may be the same as discharging gap G′ between sustain electrode 31 and scan electrodes 32 formed in display area AA. Sustain sub-electrode 31aa of non-display area BB has smaller width than transparent electrodes 31a formed in display area AA, and scan sub-electrode 32aa of non-display area BB has smaller width than transparent electrodes 32a of display area AA. For example, widths of sustain sub-electrode 31aa and scan sub-electrode 32aa are narrower than transparent electrode 31a and 32a, respectively, as shown in FIG. 2, and the narrower widths of sustain sub-electrode 31aa and scan sub-electrode 32aa would be obtained by partly removing transparent electrode originally extended into non-display area BB, respectively.

Due to these shapes of sustain and scan sub-electrodes 31aa and 32aa, no sustain discharge is directly generated between sustain sub-electrode 31aa and scan sub-electrode 32aa, when a sustain voltage is applied to sustain electrode 31 and scan electrode 32. However, the charges may be formed in discharge cell 17a, which is discharge cell formed in non-display area BB, corresponding to sustain and scan sub-electrodes 31aa and 32aa, and the charges may be supplied to neighboring discharge cells 17 in display area AA. The charges may be involved in the sustain discharge in outermost discharge cells 17 in the display area AA, and therefore, the stability of sustain discharge of the outermost discharge cells would be improved. Also, power consumption of the PDP may be reduced due to the smaller width of sustain and scan sub-electrodes 31aa and 32aa that prevent unnecessary sustain discharge in non-display area.

Sustain sub-electrode 31aa includes first member 131aa and second member 231aa, and scan sub-electrode includes first member 132aa and second member 232aa. First member 131aa and 132aa extend in the first direction (y-direction or width direction of the sustain and scan electrode), and second member 231aa and 232aa extend in the second direction (x-direction or length direction of the sustain and scan electrode). First member 131aa and second member 231aa are connected to each other, and first member 132aa and second member 232aa are connected to each other. Second members 231aa and 232aa pass discharge cells 17a formed in non-display area BB.

In the present embodiment, first members 131aa and 132aa are formed to cover first barrier rib member 16a formed at a border between display area AA and non-display area BB, as shown in FIG. 2. However, arrangement of first members is not limited to this arrangement suggested in the present embodiment.

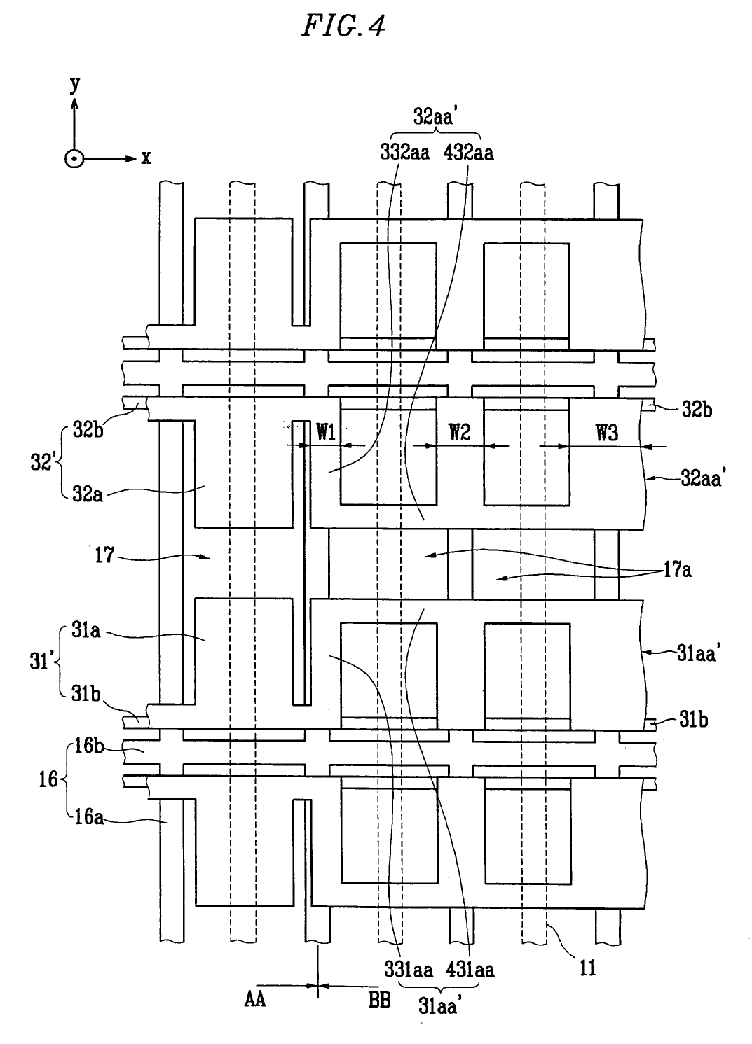

FIG. 4 is a partial plan view illustrating the arrangement of electrodes and barrier ribs of a plasma display panel constructed as a second embodiment of the present invention. The second embodiment is similar to the first embodiment in terms of the overall structure and arrangement. Therefore, the explanation will be given to the arrangements that are different from those of the first embodiment.

Referring to FIG. 4, shapes of sustain sub-electrode 31aa′ of sustain electrodes 31′ and scan sub-electrode 32aa′ of scan electrodes 32′, both of which are formed in non-display area BB, are different from the shapes of sustain sub-electrodes 31aa and scan 32aa of the first embodiment. A plurality of first members 331aa and 332aa, which extend in the first direction (y-direction), are formed in non-display area BB, and each of first members 331aa and 332aa is connected to bus electrode 31b and 32b at one end. The plurality of first members 331aa are connected to second members 431aa, so that first members 331aa and second members 431aa form an overall connected electrode arrangement.

As shown in FIG. 4, widths of first members 331aa and 332aa are different depending on the locations of first members 331aa and 332aa. Width of first members 331aa and 332aa is defined as a size of the electrode in x-direction, as depicted as W1, W2, and W3 in FIG. 4. The width of first members 331aa and 332aa increases as the distance between first members 331aa and 332aa and display area AA increases. in other words, the width of the first member increases proportionally to the distance from the first member to a boundary of the display area. Therefore, the farthest first member has the largest width, and the second farthest first member has the second largest width, and so on (W1<W2<W3 as shown in FIG. 4).

The wider first member may accumulate more charges, and the wider first member 331aa and 332aa is formed, the more the charges maybe formed in discharge cell 17a of non-display area. As a result, the discharging stability of the outermost discharge cells in the display area AA may be effectively improved by the charges supplied to discharge cell 17a of non-display area, while the charges supplied to discharge cell 17a of non-display area would not generate sustain discharge.

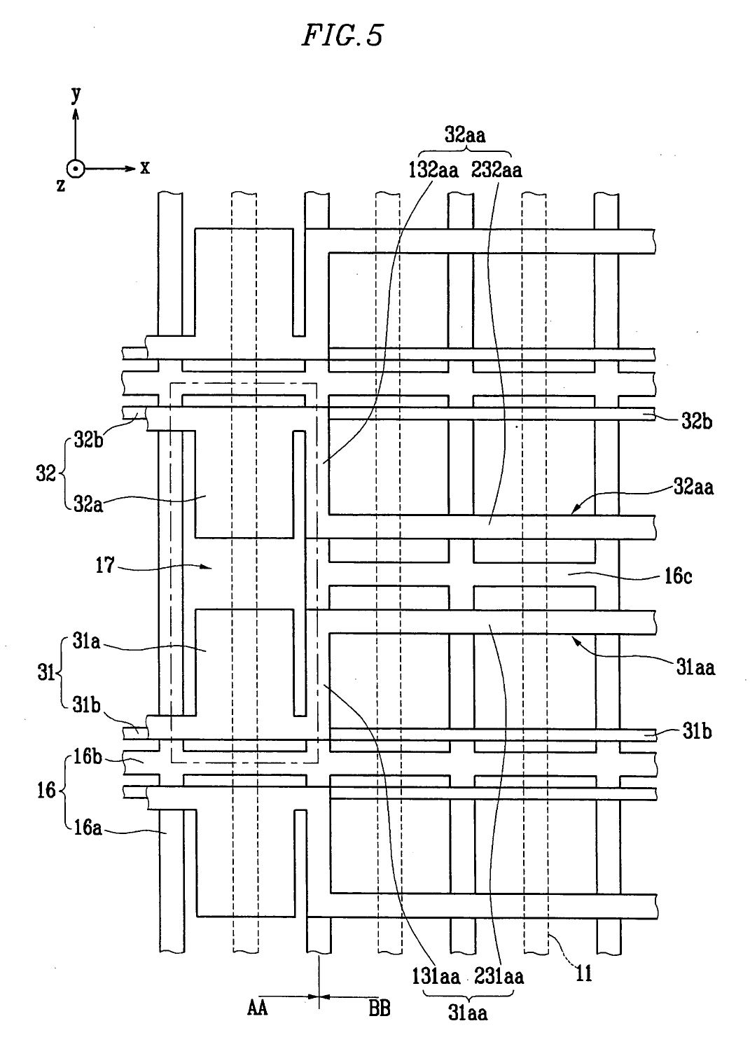

FIG. 5 is a partial plan view illustrating the arrangement of electrodes and barrier ribs of a plasma display panel according to a third embodiment of the present invention. Referring to FIG. 5, in the present embodiment, third barrier rib member 16c is formed between sustain sub-electrodes 31aa and scan sub-electrode 32aa, which forms a pair corresponding to each of discharge cells 17a (described regarding the structure shown in FIG. 2), and are placed parallel to each other in non-display area BB. In other words, third barrier rib member 16c is an additional barrier rib placed in non-display area BB between two second barrier rib members 16b. Third barrier rib member 16c extends in the second direction (x-direction) parallel to second barrier rib member 16b. More specifically, third barrier rib member 16c is placed between second member 231aa of sustain sub-electrode 31aa and second member 232aa of the scan sub-electrode 32aa.

Third barrier rib member 16c further prevents sustain discharge being generated in non-display area BB by dividing a discharge cells formed in non-display area into two sub-discharge cells. Accordingly, unnecessary generation of light is prevented in non-display area, and a contrast ratio of display area may be further improved.

Although the present embodiment shows third barrier rib member 16c placed between sustain and scan sub-electrodes 31aa and 32aa, the present invention is not limited to this arrangement presented in this embodiment. For example, third barrier rib member 16c may be placed between sustain and scan sub-electrodes 31aa′ and 32aa′ of the second embodiment shown in FIG. 4.

As explained hereinabove, the plasma display panel according to the principles of the present invention includes transparent sub-electrodes formed in the non-display area adjacent to the outermost discharge cells in the display area. The sub-electrodes form the discharge gap therebetween that is the same size as that in the display area. However, no substantial discharge occurs between the sub-electrodes because the sub-electrodes are formed smaller in width in the non-display area. As a result, unnecessary generation of light is prevented in the non-display area, and a contrast ratio may be improved in the display area. Also, a discharge current is reduced due to the narrower sub-electrodes, which leads to the reduction in power consumption.

In addition, since the sub-electrodes form a predetermined gap in the non-display area, the charges may be supplied from the non-display area to the outermost discharge cells in the display area, and the discharging stability of the outermost discharge cells in the display area may be improved.

Although an embodiment of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A plasma display panel comprising:
a first substrate;
a second substrate facing the first substrate with a space formed therebetween, the space including a display area for displaying an image and a non-display area that is formed outside the display area and displays no image;
a first electrode disposed on the second substrate and extending in a second direction, the first electrode including a first transparent electrode and a first bus electrode, the first transparent electrode including a first sub-electrode formed in the non-display area, a shape of the first sub-electrode being different from a shape of the portion of the first transparent electrode formed in the display area;
a second electrode disposed on the second substrate and extending in a second direction;
a plurality of address electrodes disposed on the first substrate and extending in a first direction, intersections of the address electrodes with a pair of the first and the second electrodes forming discharge cells in the space between the first substrate and the second substrate, each of discharge cells being formed either in the display area or in the non-display area;
a plurality of barrier ribs formed in the space between the first substrate and the second substrate, each of discharge cells being disposed between two barrier ribs; and
a phosphor layer formed on a side of the barrier ribs.

2. The plasma display panel of claim 1, comprised of the second electrode including a second transparent electrode and a second bus electrode, the second transparent electrode including a second sub-electrode formed in the non-display area, a shape of the second sub-electrode being different from a shape of the portion of the second transparent electrode formed in the display area.

3. The plasma display panel of claim 2, comprised of the first sub-electrode and the second sub-electrode being substantially parallel to each other, and being separated from each other with a predetermined gap.

4. The plasma display panel of claim 3, comprised of the first transparent electrode formed in the display area and the second transparent electrode formed in the display area being separated from each other with a predetermined gap, the gap between the first transparent electrode and the second transparent electrode both formed in the display area being substantially the same as the gap between the fist sub-electrode and the second sub-electrode.

5. The plasma display panel of claim 1, wherein a width of the first sub-electrode is smaller than a width of the portion of the first transparent electrode formed in the display area.

6. The plasma display panel of claim 2, wherein a width of the second sub-electrode is smaller than a width of the portion of the second transparent electrode formed in the display area.

7. The plasma display panel of claim 1, comprised of the first sub-electrode including a first member extending substantially in the first direction from the first bus electrode and a second member extending substantially in the second direction from an end of the first member.

8. The plasma display panel of claim 7, comprised of the first member substantially covering one of the barrier ribs that extends in the first direction.

9. The plasma display panel of claim 8, comprised of the first member formed adjacent to a boundary of the display area.

10. The plasma display panel of claim 1, comprised of the first sub-electrode including a plurality of first members extending substantially in the first direction from the first bus electrode and a second member that extends substantially in the second direction and connects to ends of the first members.

11. The plasma display panel of claim 10, wherein a width of the first member increases proportionally to the distance from the first member to a boundary of the display area.

12. The plasma display panel of claim 1, comprised of the discharge cells formed in the non-display area including at least two sub-discharge cells, each of the sub-discharge cells being surrounded by the barrier ribs.

13. The plasma display panel of claim 2, comprised of the barrier ribs including a plurality of first barrier rib members extending in the first direction and a plurality of second barrier rib members extending in the second direction, each of the first barrier rib members crossing at least one of the second barrier rib members.

14. The plasma display panel of claim 13, comprised of the barrier ribs further including a plurality of third barrier rib members formed in the non-display area and extending in the second direction, both of a pair of the first sub-electrode and the second sub-electrode and one of the third barrier rib members disposed between the second barrier rib members, the one of the third barrier rib members also disposed between the first sub-electrode and the second sub-electrode.

15. A plasma display panel comprising:
a first substrate;
a second substrate facing the first substrate with a space formed therebetween, the space including a display area for displaying an image and a non-display area that is formed outside the display area and displays no image;
a first electrode disposed on the second substrate and extending in a second direction, the first electrode including a first transparent electrode and a first bus electrode, the first transparent electrode including a first sub-electrode formed in the non-display area, a width of the first sub-electrode being smaller than a width of the portion of the first transparent electrode formed in the display area;
a second electrode disposed on the second substrate and extending in a second direction, the second electrode including a second transparent electrode and a second bus electrode, the second transparent electrode including a second sub-electrode formed in the non-display area, a width of the second sub-electrode being smaller than a width of the portion of the second transparent electrode formed in the display area;
a plurality of address electrodes disposed on the first substrate and extending in a first direction, intersections of the address electrodes with a pair of the first and the second electrodes forming discharge cells in the space between the first substrate and the second substrate, each of discharge cells being formed either in the display area or in the non-display area;

16. The plasma display panel of claim 15, comprised of the first sub-electrode and the second sub-electrode being substantially parallel to each other and being separated from each other with a predetermined gap, and comprised of the first transparent electrode formed in the display area and the second transparent electrode formed in the display area being separated from each other with a predetermined gap, the gap between the first transparent electrode and the second transparent electrode both formed in the display area being substantially the same as the gap between the fist sub-electrode and the second sub-electrode.

17. The plasma display panel of claim 16, comprised of the first sub-electrode including a first member extending substantially in the first direction from the first bus electrode and a second member extending substantially in the second direction from an end of the first member.

18. The plasma display panel of claim 16, comprised of the first sub-electrode including a plurality of first members extending substantially in the first direction from the first bus electrode and a second member that extends substantially in the second direction and connects to ends of the first members.

19. The plasma display panel of claim 18, wherein a width of the first member increases proportionally to the distance from the first member to a boundary of the display area.

20. The plasma display panel of claim 15, further comprising:
a plurality of first barrier rib members extending in the first direction and formed in the space between the first substrate and the second substrate;
a plurality of second barrier rib members extending in the second direction and formed in the space between the first substrate and the second substrate, each of the first barrier rib members crossing at least one of the second barrier rib members; and
a third barrier rib member formed in the non-display area and extending in the second direction, the third barrier rib members disposed between the second barrier rib members.
